(19) United States
(12) Patent Application Publication
(10) Pub. No.: US 2008/0229419 A1
(43) Pub. Date: Sep. 18, 2008

(54) Automated identification of firewall malware scanner deficiencies

(75) Inventors: Vladimir Holostov, Hadera (IL); John Neystadt, Kfar Saba (IL)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/724,705

(22) Filed: Mar. 16, 2007

(51) Int. Cl. G06F 12/14

(52) U.S. Cl. 726/24

(57) ABSTRACT

Automated identification of deficiencies in a malware scanner contained in a firewall is provided by correlating incident reports that are generated by desktop protection clients running on hosts in an enterprise that is protected by the firewall. A desktop protection client scans a host for malware incidents, and when detected, analyzes the host's file access log to extract one or more pieces of information about the incident (e.g., identification of a process that placed the infected file on disk, an associated timestamp, file or content type, malware type, hash of such information, or hash of the infected file). The firewall correlates this file access log information with data in its own log to enable the firewall to download the content again and inspect it. If malware is detected, then it is assumed that it was missed when the file first entered the enterprise because the firewall did not have an updated signature. However, if the malware is not detected, then there is a potential deficiency.

### BACKGROUND

Public networks such as the Internet are commonly used to allow businesses and consumers to access and share information from a variety of sources. However, security is often a concern when accessing the Internet. Particularly for businesses, which often allow Internet conductivity to their private networks, there is a threat of malware being downloaded from a website which may contain viruses, trojan horses, or other malicious executable code (collectively referred to as “malware”) that may infect computers inside the private network. To prevent such infections, network administrators often employ a firewall—a combination of hardware and software that is usually located between the private network and an Internet gateway. Requests for information over the Internet from nodes within the network are routed through the firewall. Similarly, information received from the Internet is first received at the firewall before being distributed to nodes in the network. Thus, the firewall is able to monitor, stack, and filter all requests bound for or incoming from the Internet, to ensure that outgoing requests adhere to stated policies, and incoming content does not contain malware.

The incoming content may be transported using a variety of different protocols including, for example, HTTP (Hypertext Transfer Protocol), FTP (File Transfer Protocol), or SMTP (Simple Mail Transfer Protocol). The firewall typically contains a module that is capable of extracting a file or other content from the incoming data stream which is then scanned by one or more antivirus engines. The firewall's ability to understand the protocol can be negatively affected by the variety of encoding and encapsulation methods that are applied to the files and content. Some of these encoding and encapsulation methods may be new, while others are evolutions of existing methods. Consequently, there is a chance that a virus or other malware will pass through a vulnerable firewall undetected due to such deficiency and infect a machine inside the network. The ability to discover such firewall scanner deficiencies in an efficient and automated manner would thus be desirable.

This Background is provided to introduce a brief context for the Summary and Detailed Description that follows. This Background is not intended to be an aid in determining the scope of the claimed subject matter nor be viewed as limiting the claimed subject matter to implementations that solve any or all of the disadvantages or problems presented above.

### SUMMARY

An arrangement for automating the identification of deficiencies in a malware scanner contained in a firewall is provided by correlating incident reports that are generated by desktop protection clients running on hosts in an enterprise that is protected by the firewall. A desktop protection client scans a host for malware incidents, and when detected, analyzes the host's file access log to extract one or more pieces of information about the incident that is usable in a correlation process that is typically performed by the firewall. The information may include, for example, the identification of the process that placed the infected file on disk, a timestamp associated with the process, the file or content type, malware information or type (e.g., virus, trojan horse, spyware, rootkit etc.) or a hash of any of such information. The identifying information from the host's file access log is received by the firewall which then correlates the data with data in its own firewall log. The correlation enables the firewall to locate the host request for the content of interest and the corresponding URL (Uniform Resource Locator) for the source of the infected content, such as a web site on the Internet. The firewall downloads the content again and inspects it for malware.

If the malware scanner in the firewall detects the malware, then it is assumed that it missed detecting the malware when the file first entered the enterprise because it did not have an updated signature (while the desktop protection client, which scanned the file at a later time, did have such signature update). However, if the malware scanner does not detect the malware, then there is a potential deficiency. In this case, information about the malware incident is provided to a response center (typically maintained by the firewall vendor). The response center downloads the content and subjects it to both automated and manual analysis to determine if the malware bypassed the firewall due to a deficiency in the malware scanner. If so, then the response center may issue a hot fix, service pack, patch, or update to remediate the deficiency.

Advantageously, the present automated identification of firewall malware scanner deficiencies enables new and undiscovered channels of malware infiltration to be efficiently identified through the correlation of actual field data that is collected from one or more enterprises. For example, such arrangement enables detection of issues with the firewall's ability to unpack content from newly developed encoding and encapsulation packages.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative environment in which the present automated identification of firewall malware scanner deficiencies may be implemented;

FIG. 2 is a simplified block diagram of an illustrative firewall including a network engine, a content navigator, and a plurality of antivirus engines;

FIG. 3 depicts alternative illustrative scenarios that may appear during a scan of incoming traffic by a firewall malware scanner;

FIG. 4 is a diagram showing an illustrative arrangement for correlating between an infection incident discovered by a desktop protection client and a firewall log associated with a process that retrieved malware;

FIG. 5 shows processes and associated data maintained by the desktop protection client as entries in its file access logs; and

FIGS. 6 and 7 provide a flow chart of an illustrative method that may be facilitated using the correlation arrangement shown in FIG. 4.

### DETAILED DESCRIPTION

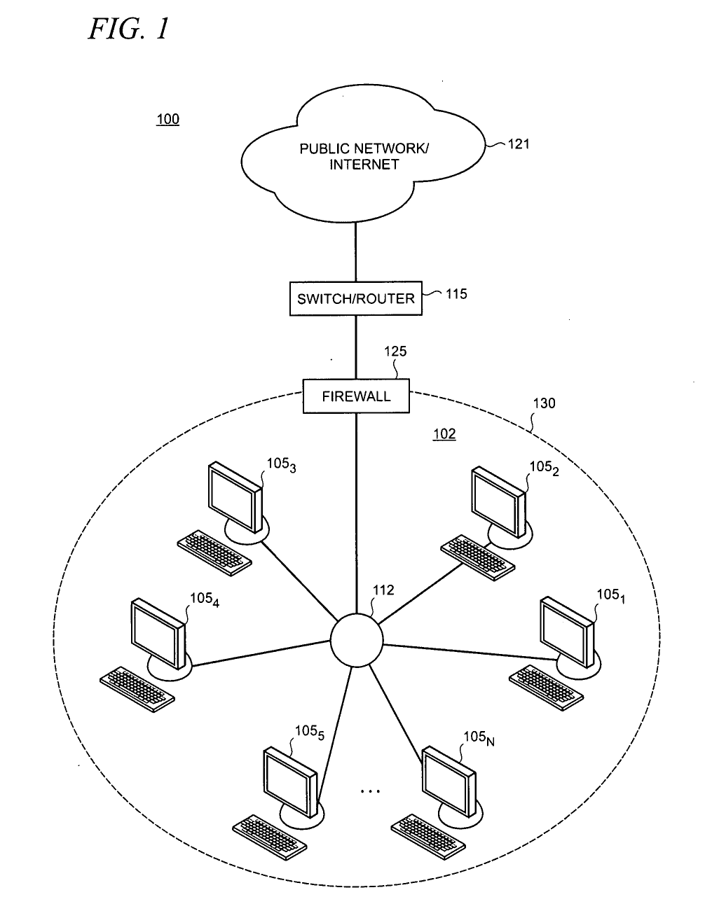

FIG. 1 shows an illustrative environment 100 in which the present automated identification of firewall malware scanner deficiencies may be implemented. An enterprise, such as an office in a business uses an internal network that uses a variety of computers or workstations (collectively called “hosts” and identified by reference numeral 105-1, 2, . . . N) that are arranged to communicate over an internal network 1112. A network gateway such as a switch or router 115 couples the internal network 112 to an external network such as a public network or the Internet 121.

A firewall 125 monitors traffic between the internal network 112 and the public network/Internet 121, and scans and inspects incoming traffic for malware. The firewall 125 thus functions to provide a zone of security 130 around the enterprise 102 by preventing users from downloading malware from the Internet and accordingly, it is often termed a perimeter or edge firewall. In some applications of the present automated firewall malware scanner deficiency identification, the functionality provided by firewall 125 may be embodied in a central server or a proxy server type device.

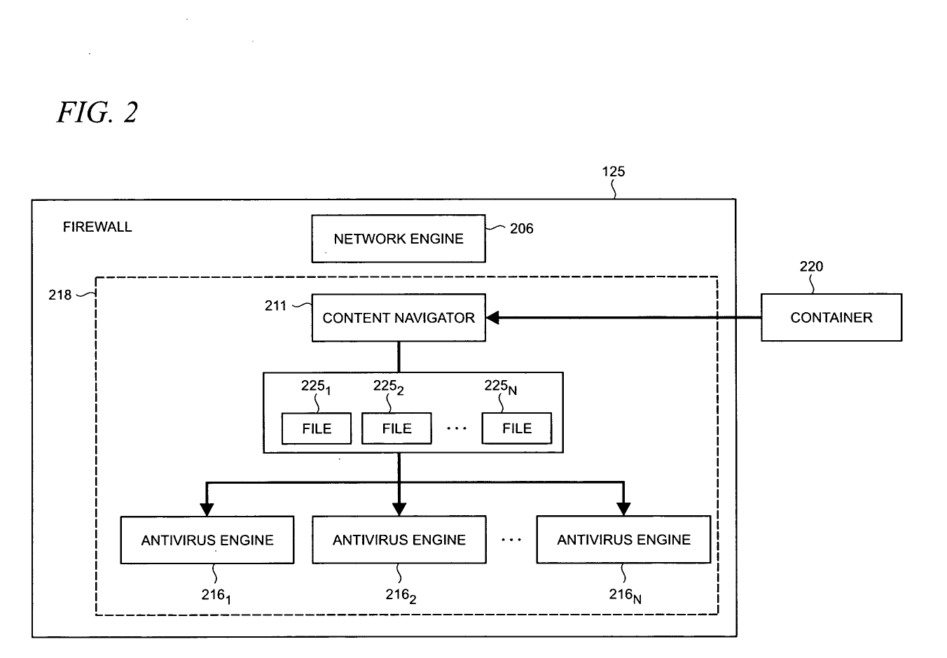

As shown in FIG. 2, the firewall 125 in this illustrative example, comprises three functional components: a network engine 206, a content navigator 211 and one or more antivirus engines 216-1, 2 . . . N. The combination of content navigator 211 and the antivirus engines 216 is referred to as a malware scanner and indicated by reference numeral 218. It is emphasize that the functional components shown here are merely illustrative and that other combinations of components may be utilized in some applications. In addition, some of the functions provided by the discretely embodied components shown in FIG. 2 may be alternatively arranged as part of the core functionality provided by other components that make up the firewall of 125.

The network engine 206 is arranged to detect and route traffic between the internal and external networks 112 and 121 shown in FIG. 1. The network engine 206 is thus configured with common functionalities including for example, packet-based filtering, or network- or application-layer type network traffic handling.

The content navigator 211 is arranged to unpack content such as files from a container 220 and then transfer the unpacked files 225-1, 2 . . . N to the antivirus engines 216. Container 220 may be arranged to take many forms for example, an archive or a Zip file, that typically use data compression or encoding to preserve file space. Such compression and encoding techniques applied to these containers are not necessarily static, where new container types are developed as well as variations from existing container types. As a result, the content navigator 211 and the firewall 125 have the potential for misinterpreting or misidentifying malware signatures (i.e., a unique pattern used to identify and detect specific instances of malware) of files that may be packed in the container 220, as discussed below.

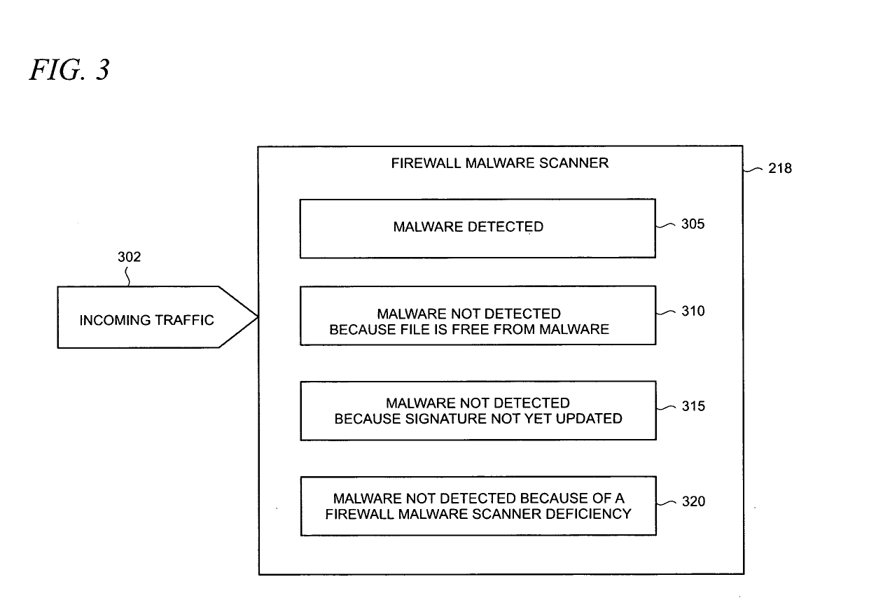

FIG. 3 depicts alternative illustrative scenarios that may occur as a result of malware scanning of incoming traffic 302 to the firewall 125 (FIG. 1) performed by the malware scanner 218. In the first scenario indicated by reference numeral 305, a malware is detected by the firewall malware scanner 218 because a signature available to the firewall malware scanner 218 matches a signature of known malware. Such malware signatures are typically stored in a signature store accessible by antivirus engine 216 and are periodically updated by the firewall vendor.

In the second illustrative scenario indicated by reference numeral 310, the firewall malware scanner 218 does not detect malware because a scanned file of interest in the incoming traffic 302 is free from malware, and is thus considered “clean.”

In the third illustrative scenario indicated by reference numeral 315, inspection of an incoming file does not reveal any malware even though the file actually does contains malware. In this scenario, there is no intrinsic deficiency in the malware scanner 218, but rather just a lack of an updated signature that matches the malware contained in the file. While the occurrence of such scenario may cause some inconvenience for the enterprise and result in some costs, the root cause of the infection is merely an issue associated with the timing of the signature updates.

In the fourth illustrative scenario indicated by reference numeral 320, inspection of an incoming file does not reveal any malware even though the file actually does contain malware. Unlike the third scenario, this is not a result of signature update timing. Instead, there is a deficiency in the firewall malware scanner 218. The present firewall malware scanner deficiency identification is intended to differentiate between the third and the fourth scenarios described above in an automated manner by correlating between an infection incident discovered by a host in the enterprise and logs maintained by the firewall 125. The identification methodology is discussed below.

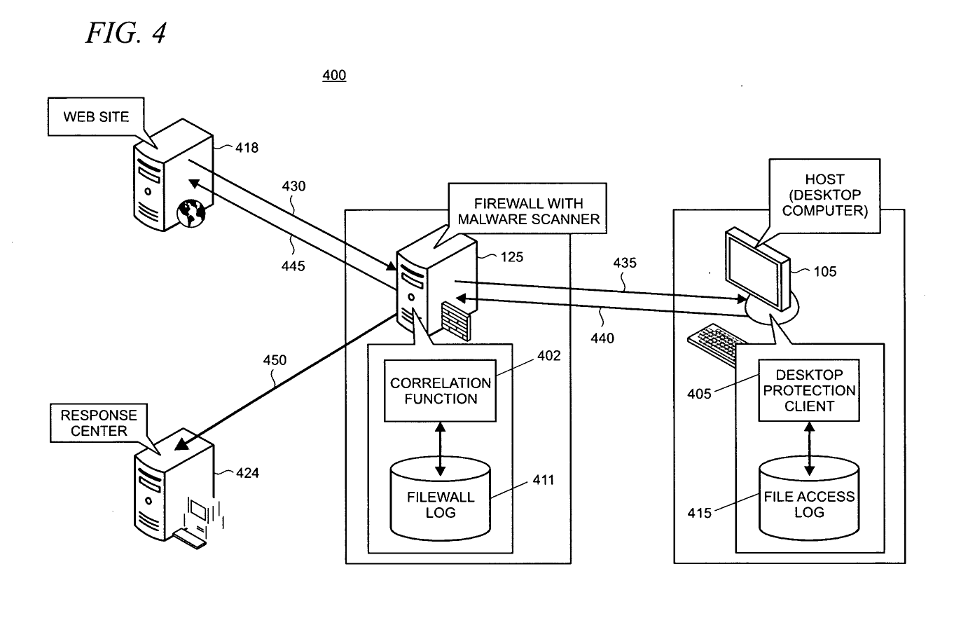

FIG. 4 is a diagram showing an illustrative arrangement 400 using a correlation function 402 for correlating between an infection incident discovered by a desktop protection client 405 and a firewall log 411 associated with a process that retrieved malware. The correlation function 402, in this illustrative example, is shown as being supported by the firewall 125. However, in alternative arrangements, the correlation function is supported by either a host, or a separate discretely embodied platform such as a server.

As shown in FIG. 4, the desktop protection client numeral 405 is incorporated in a host 105 in the enterprise 100 (FIG. 1). The desktop protection client 405 is typically arranged as an application that runs on each individual host in the enterprise that detects infections in real time or during periodic scanning. In each case, the desktop protection client 405 logs data associated with the detected incident in a file access log 415.

In an alternative arrangement, a separate module is configured to monitor and log data associated with file access to the file access log 415. For example, a plug-in to a web browser such as Microsoft Internet Explorer® is configured to perform monitoring of the files that are downloaded with the browser, and also logs descriptive data that is used to enhance the correlation between the infection incident and the firewall log. Such arrangement may be beneficial in certain applications since many users utilize a web browser as the primary tool to access and download content, some of which may contain malware.

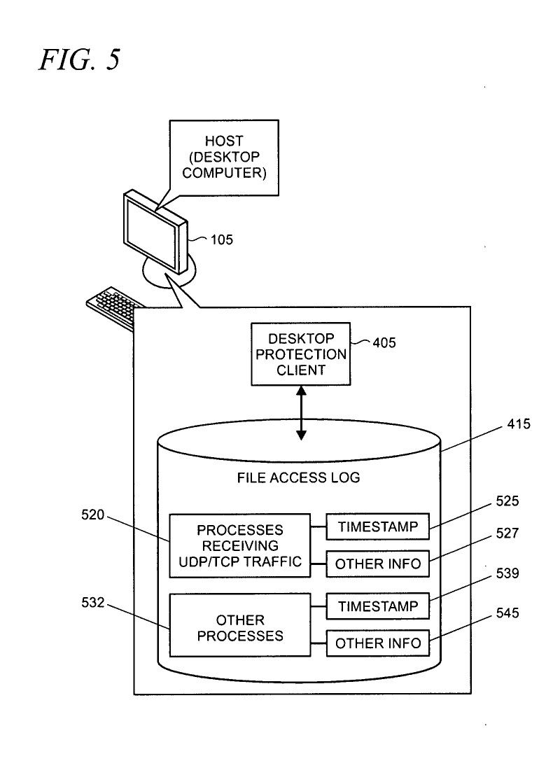

For each detected incident, the desktop protection client 405 writes an entry into its file access log 415. As indicated in FIG. 5, the desktop protection client 405 is required to identify the process that performs any modifying access to the host's file system. Thus, a subsequent analysis of the file access log 415 will identify the process that placed any infection on the host. In some applications of the present automated identification of malware scanner deficiencies, the desktop protection client 405 will maintain a list of processes 520 in which network access is involved, for example UDP/TCP traffic (User Datagram Protocol/Transport Control Protocol). File access log entries are also made for the timestamp 525 associated with the incident. In addition, other potentially relevant information 527 can be monitored and be written to the file access log 415 depending on the requirements of a specific application. For example, information which describes the file or its content, or the malware-type involved (e.g., e.g., virus, trojan horse, spyware, rootkit etc.) may be monitored and written in the file access log 415.

In addition, or in an alternative implementation, processes other than those that involved network access, are usable as indicated by reference numeral 532, along with an associated timestamp 539 or other relevant information 545. For example, it may be useful to monitor processes associated with applications such as an Adobe Acrobat® plug-in which can perform file operations on content downloaded by a web browser. Log entries are typically kept on a persistent basis for some pre-defined time period.

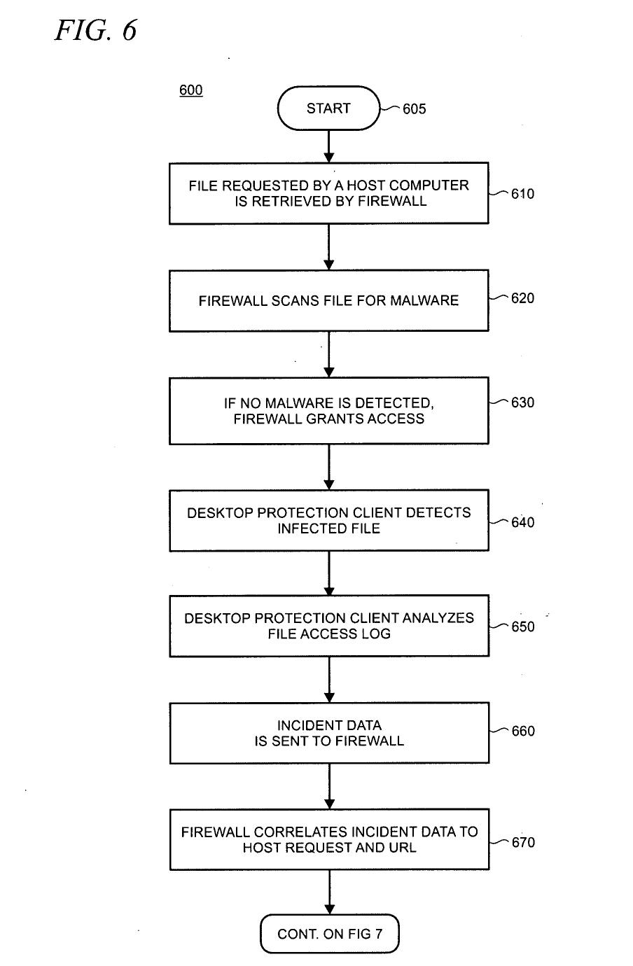

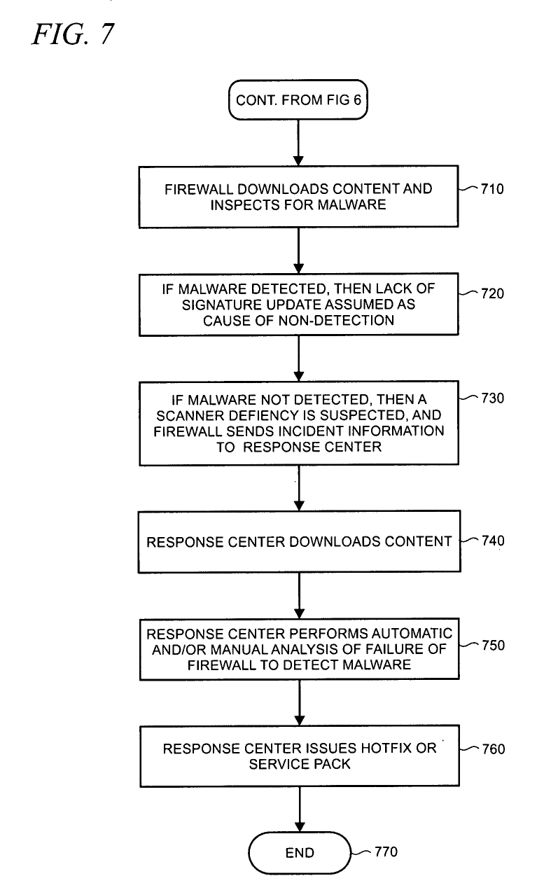

Returning again to FIG. 4, the illustrative arrangement 400 further includes a web site 418 that is normally accessed by the host 105 via the firewall 125 through an external network such as the Internet 121 (FIG. 1). A response center 424 is further in operative communication with the firewall 125, typically over the Internet 121, a private network, or virtual private network arrangement. The response center 424 is generally operated by a vendor (or third-party provider under contract by the vendor, for example) that provides technical assistance and support to its firewall products in the field. More specifically, malware signature updates for the firewall 125 may be received from the response center 424, in addition to other sources. In addition, the response center 424 is arranged to perform the methodologies noted in the flowcharts shown in FIGS. 6 and 7.

FIGS. 6 and 7 provide a flow chart of an illustrative method 600 that may be facilitated using the arrangement 400 shown in FIG. 4. Illustrative method 600 is intended to be performed by the components in arrangement 400 in an automated manner, in most typical applications, without the need for user intervention.

Illustrative method 600 starts at block 605. At block 610, the host 105 requests access to a file from the web site 418 which is retrieved by the firewall 125, as shown by line 430 in FIG. 4.

At block 620 in FIG. 6, the firewall 125 scans the retrieved file for malware. At block 630, if the scan detects no malware, then the firewall 125 allows the host 105 to access the file, as shown by line 435 in FIG. 4.

At block 640, the desktop protection client 405 performs a scan of the host computer 105 and detects that the file from the web site 418 is infected with malicious code. This detection by the desktop protection client 405 when the firewall scanner missed the detection could occur, for example, because it was more recently updated with new malware signatures as compared with the firewall 125.

At block 650, the desktop protection client 405 analyzes entries to the file access log 415. For example, the desktop protection client 405 finds that the file of interest was created through a process invoked by a web browser application on a particular date and time. As noted above in the text accompanying FIG. 5, the desktop protection client writes entries that describe the name of the process performing the operation (e.g., writing the file to disk and/or running the executable code) that led to the infection along with its timestamp. At block 660, data about the incident, including the process identification, timestamp, and a description of the malware incident type (e.g., virus, trojan horse, spyware, rootkit etc.) is sent to the firewall 125, as indicated by line 440 in FIG. 4, for further analysis. At block 670 in FIG. 6, in response to the data received from the desktop protection client 405, the original file request by the host 105 is retrieved by the firewall 125 by correlating the host request to a corresponding URL (Uniform Resource Locator) stored in the firewall log 411. Typically, the firewall 125 will locate the log entries in the firewall log 411 that are associated with the identified process that fall within the relevant timeframe, and verify that some data was actually retrieved by the identified process.

At block 710 in FIG. 7, the firewall 125 will generally check with the response center 424 that its malware signatures are current, and if so will attempt to download the original file of interest once again using the URL, as indicated by line 445 in FIG. 4. In some cases, this may not be possible if the site is no longer available, as is often the case with malware sites which commonly have a transient nature. If the download is successful, the firewall 125 will inspect it for malware. Optionally, the firewall uses a methodology to verify that the downloaded content is the same as that originally requested by the host. For example, a conventional hash function (e.g., CRC32, SHA-1, MD5 etc.) may be applied to each file, and the output of the hash function compared.

At block 720, if the result of the inspection is a detection of malware, then the cause of the original non-detection by the firewall 125 is assumed to be the lack of malware signature update. That is, the failure of the firewall 125 to detect the malware in the file at the time of the host's original request (i.e., at block 610 in FIG. 6) is not a result of a malware scanner deficiency, but is instead an issue of timing with regard to the signature updates to the firewall 125. Thus, if the firewall 125 had been updated with the signature at the time of the original request, it would have detected the malware.

By comparison, at block 730 if the result of the firewall's inspection is that the malware is not detected, then given that the signatures are current, there is likely an intrinsic deficiency in the malware scanner in the firewall 125 that is not simply a result of update timing. For example, there could be some issue with the content navigator 211 (FIG. 2) in the malware scanner 218 being able to unpack content from a container. Alternatively, a design, integration, user, or a systemic issue may be responsible for the deficiency.

In most cases, the firewall 125 sends an incident report to the response center 424, as indicated by line 450 in FIG. 4. This incident report may contain data from the firewall log 411 as well as data from the host computer's file access log 415 (e.g., process identifier, timestamp, and threat type). It is noted that the incident report may not always be transmitted in all cases in order to preserve user and/or enterprise privacy. In optional arrangements, the firewall 125 will not automatically send the incident report to the response center 424. Instead, the incident report will be subject to review and approval by an administrator or security analyst prior to being transmitted outside the enterprise.

At block 740, the response center 424 uses the data in the incident report received from the firewall 125, including the identified URL, to attempt to download the original file of interest that the host's desktop protection client identified as containing malware. At block 750, by correlating incident report data from the file access log 415, firewall log 411, and its own local data which describes security incidents reported from other systems and enterprises, the response center 424 can analyze suspected sources of the malware. For example, by correlating incident reports received from a plurality of firewalls representing a variety of enterprises, the response center 424 may be able to reduce the number of potential sources of the malware.

In light of the available data, the response center can make a determination as to whether the malware was able to get past the firewall 125 as a result of a malware scanner deficiency. In addition, by correlating data from a range of sources from actual field applications, the confidence and accuracy of the conclusions of the response center's analysis are improved as compared with analyses of potential deficiencies that may rely on simulation or modeling to replicate an enterprise environment. The response center 424 typically uses a combination of automated and manual analyses to understand the failure of the malware scanner in the firewall 125 to detect the malware.

At block 760, the response center 424 may issue a hot fix, service pack, patch, or other update to the firewall 125 to rectify the malware scanner deficiency as may be required. Illustrative method 600 ends at block 770.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium containing instructions which, when executed by one or more processors disposed in an electronic device, performs a method for investigating malware incidents, the method comprising the steps of:
maintaining a file access log, the log containing entries for processes operating on a host and timestamps associated with respective processes;
scanning a host to detect an incident of suspected malware residing on the host; and
transmitting an incident report, in response to detection of the incident, to a gateway device, the gateway device including a malware scanner and being arranged to implement security measures in accordance with defined security policies, the incident report containing data from the file access log including identification of a process associated with the incident and a timestamp associated with the process.

2. The computer-readable medium of claim 1 in which the malware is one of virus, trojan horse, rootkit, spyware, or malicious executable code.

3. The computer-readable medium of claim 1 in which the gateway device is arranged to provide enterprise-level security to a plurality of hosts, the hosts being selected from computers, workstations, or terminals.

4. The computer-readable medium of claim 1 in which the gateway device is one of proxy server, central server, or firewall.

5. The computer-readable medium of claim 1 in which the processes are processes that receive network traffic.

6. The computer-readable medium of claim 1 in which the scanning is performed in real time or performed periodically.

7. A method performed by a firewall for identifying a deficiency in a malware scanner disposed in the firewall, the method comprising the steps of:
receiving data from a host in an enterprise protected by the firewall, the data indicating a suspected incident of malware being resident on the host and further identifying a host process associated with the incident;
correlating the data received from the host with firewall log entries i) to confirm that the host process resulted in a file being retrieved at the firewall and, ii) to identify a source of the retrieved file;
downloading the file from the identified source; and
inspecting the downloaded file for malware.

8. The method of claim 7 including a further step of obtaining available signature updates, the obtaining being performed prior to the downloading so that the inspecting is performed using currently-available malware signatures.

9. The method of claim 8 including a further step of generating an incident report for transmission to a response center if the inspecting does not result in detection of the malware, the incident report containing data describing the incident.

10. The method of claim 9 including a further step of obtaining an approval from a user prior to the transmission to the response center.

11. The method of claim 9 in which the incident report data includes file access log data obtained from the host.

12. The method of claim 9 in which the incident report data includes firewall log data.

13. The method of claim 9 in which the data describing the incident comprises at least one of identification of the host process, a timestamp associated with the host process, or a description of the malware.

14. The method of claim 7 in which the source is a web site accessible from the Internet.

15. A method for providing a service for addressing deficiencies in firewall malware scanning, the method comprising the steps of:
receiving one or more incident reports generated by one or more firewalls, each of the firewalls including a malware scanner, and each of the one or more incident reports including data describing an incident in which the malware scanner did not detect malware contained in incoming traffic to the one or more firewalls; and
determining, using the received one or more incident reports, if a deficiency in the malware scanner was a cause for the malware to be undetected by the malware scanner.

16. The method of claim 15 including a further step of providing remediation in response to the determining, the remediation comprising issuing, to the one or more firewalls, one of a hot fix, service pack, patch, or update.

17. The method of claim 15 in which the determining includes correlating the received one or more incident reports to reduce a number of potential suspected sources of the malware.

18. The method of claim 15 including a further step of preparing a report regarding the deficiency for review by an administrator to assist a manual analysis.

19. The method of claim 18 in which the steps of receiving, determining, and preparing are performed in an automated manner without requiring user intervention.

20. The method of claim 15 in which the service is provided by, or on behalf of a vendor of a product that incorporates the malware scanner.
